(19) United States
(12) Patent Application Publication
(10) Pub. No.: US 2026/0045696 A1
(43) Pub. Date: Feb. 12, 2026

(54) NON-UNIFORM ARRAY FACE FOR A MULTIBAND ANTENNA

(71) Applicant: JOHN MEZZALINGUA ASSOCIATES, LLC., Liverpool, NY (US)

(72) Inventor: Anoop TIWARI, Syracuse, NY (US)

(21) Appl. No.: 18/874,065

(22) PCT Filed: Oct. 23, 2024
(86) PCT No.: PCT/US2024/052644

§ 371 Date: Dec. 11, 2024

Related U.S. Application Data
(60) Provisional application No. 63/593,401, filed on Oct. 26, 2023.

(51) Int. Cl. H01Q 5/48; H01Q 15/14; H01Q 21/06

(52) U.S. Cl. CPC H01Q 5/48; H01Q 15/14; H01Q 21/062

(57) ABSTRACT

An antenna array comprises a reflector; a plurality of first dipoles disposed on the reflector, the plurality of first dipoles arranged in a plurality of columns; and a plurality of second dipoles disposed on the reflector, the plurality of second dipoles arranged in a plurality of clusters, wherein each of the the plurality of first dipoles is configured to radiate in a first frequency band, and each of the plurality of second dipoles is configured to radiate in a second frequency, wherein the first frequency band is higher in frequency than the second frequency band, wherein the plurality of columns comprises two inner columns and two outer columns, wherein the two inner columns have more first dipoles than the two outer columns, wherein the two inner columns are spaced apart along a horizontal axis by a first distance and where in the two outer columns are respectively spaced apart along the horizontal axis from an adjacent column by a second distance, the second distance being greater than the first distance.

### BACKGROUND OF THE INVENTION

Modern cellular telecommunications standards such as 5G and 4G require the use of multiple frequency bands. Accordingly, cellular antennas, such as macro antennas that are deployed on cell towers, must be configured to operate in multiple frequency bands: e.g., mid band (MB) (1695-2690 MHz), and C-Band and CBRS (Citizens Broadband Radio Service) (3.4-4.2 GHz). Challenges occur in designing such a multiband antenna because design constraints such as wind loading require that the multiband antenna have a minimal profile, and packing antenna dipoles of different frequencies in close proximity to each other causes inter-band interference such as cross polarization. Another challenge is that certain frequency bands involve stringent gain performance requirements.

Antennas for urban deployments must have 360 degrees of coverage for these bands using a cylindrical antenna that must be as small as possible. These cylindrical antennas typically have three internal array faces that are arranged in a triangular fashion, each encompassing 120 degrees of coverage. The combination of the three coverages yields a quasi-omni antenna gain pattern.

A quasi-omni antenna may have different required modes of operating for each frequency band. For example, an antenna may need to operate under 8T8R (8 Transmit 8 Receive) in the C-Band and under 4×4 MIMO (Multiple Input Multiple Output) in the midband. Having two different arrays (e.g., one C-Band and one midband) with each operating in this manner creates great challenged for antenna designers, given that the area of the array face must be as small as possible.

Accordingly, what is needed is an antenna array face that operates in an 8T8R mode in the C-band and in a 4×4 MIMO mode in the midband, with a high-quality pattern for both, and having a small profile.

### SUMMARY OF THE INVENTION

An aspect of the present disclosure involves an antenna array. The antenna array comprises a reflector; a plurality of first dipoles disposed on the reflector, the plurality of first dipoles arranged in a plurality of columns; and a plurality of second dipoles disposed on the reflector, the plurality of second dipoles arranged in a plurality of clusters, wherein each of the the plurality of first dipoles is configured to radiate in a first frequency band, and each of the plurality of second dipoles is configured to radiate in a second frequency, wherein the first frequency band is higher in frequency than the second frequency band, wherein the plurality of columns comprises two inner columns and two outer columns, wherein the two inner columns have more first dipoles than the two outer columns, wherein the two inner columns are spaced apart along a horizontal axis by a first distance and where in the two outer columns are respectively spaced apart along the horizontal axis from an adjacent column by a second distance, the second distance being greater than the first distance.

### BRIEF DESCRIPTION OF DRAWINGS

FIG. 1 Illustrates an exemplary quasi-omni antenna having three array faces according to the disclosure.

FIG. 2 illustrates an exemplary non-uniform array face according to the disclosure.

FIG. 3 illustrates another exemplary non-uniform array face according to the disclosure.

FIG. 4 illustrates an exemplary C-Band dipole that may be deployed in either exemplary array face of FIGS. 2 and 3.

FIG. 5 illustrates an exemplary Midband dipole that may be deployed in either exemplary array face of FIGS. 2 and 3.

### DETAILED DESCRIPTION OF THE INVENTION

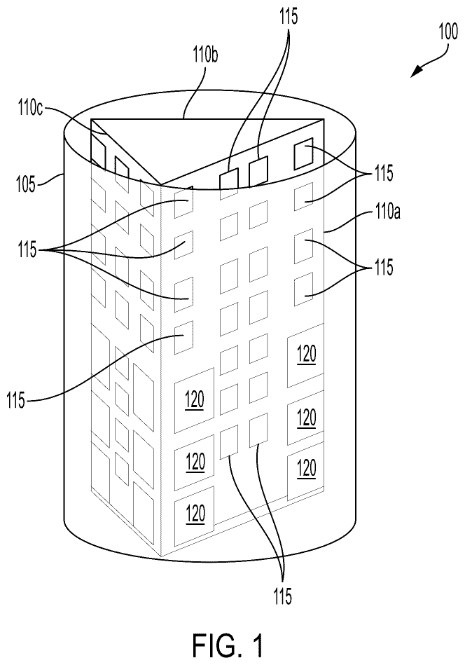

FIG. 1 Illustrates an exemplary quasi-omni antenna 100 having three array faces 110a, 110b, and 110c, which are arranged so that they are angularly spaced (offset in azimuth) at 120 degrees and each has a sector width of 120 degrees. The three array faces 100a/b/c are housed within a radome 105. The array faces 110a/b/c may be identical. Accordingly, any reference to “array face 110” may refer to any or all of them. Array face 110 has a plurality of C-Band dipoles 115 and Midband dipoles 120 that are arranged in columns.

Each of the C-band dipoles 115 and Midband dipoles 120 may operate with two distinct RF (Radio Frequency) channels on two orthogonal polarization states (e.g., +/−45 degrees). Accordingly, it will be understood that any given dipole 115/120 may receive and transmit on two distinct signals of the same frequency band.

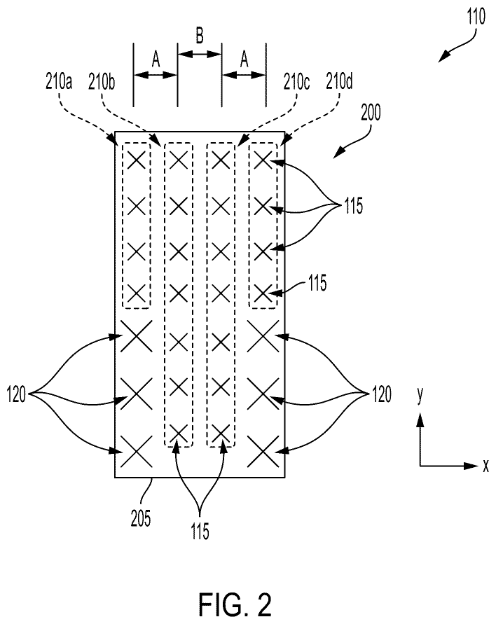

FIG. 2 illustrates an exemplary non-uniform array face configuration 200 according to the disclosure. Exemplary array face configuration 200 is a particular embodiment of array face 110. Exemplary array face configuration 200 has a plurality of C-Band dipoles 115 that are arranged in four C-band columns 210a, 210b, 210c, and 210d and disposed on reflector 205. Of the four C-band columns are two inner C-band columns 210b/c and two outer C-band columns 210a/d. Also disposed on reflector 205 is a plurality of Midband dipoles 120 that are arranged in two clusters of two dipoles on reflector 205. The clusters have Midband dipoles 120 arranged columns. Each of the clusters is disposed colinear with a corresponding outer C-band column 210a/d.

As illustrated in exemplary array face configuration 200, C-band columns 210a and 210d each have four C-band dipoles 115 and are disposed at the outer edges of reflector 205 in the azimuth (or x-axis) direction. C-band columns 210b and 210c are disposed adjacent to and on either side of a vertical centerline (not shown) of reflector 205. The four C-Band columns 210a-d may be arranged so that their uppermost constituent C-band dipole 115 in the positive y-axis direction are aligned along a line in the x-axis direction. C-band columns 210a-d are spaced such that the distance between the two inner C-band columns 210b/c is equal to a distance B; leftmost outer column 210a is spaced from adjacent C-band column 210b by a distance A; and rightmost C-band column 210d is spaced from adjacent C-band 210c column by the same distance A. As illustrated, the distance A is larger than the distance B. The distances A and B may be expressed proportionally to the center frequency of the operating band, in this case, the C-Band. For example, distance A may be 0.5-0.8λ), and distance B may be 0.4-0.75λ, where λ is the center frequency of the operating band. A preferred value for A and B may be the center values of their respective ranges. Although these values are presented as ranges, distance A is always greater than distance B.

The C-band dipoles 115, as arranged in columns 210a/d, may be respectively coupled to distinct pairs of ports (not shown) so that, for example, all of the C-band dipoles 115 in C-band column 210a radiate in two RF signals, in two orthogonal transmissions. The C-band dipoles in the other C-band columns, 210b/c, may be coupled to distinct pairs of ports (not shown). If the four pairs of ports are coupled to the same two RF signals, but each with its own amplitude and phase weighting, then the C-band dipoles 115 of array face configuration 200 may implement beamforming to enable scanning of a service beam made narrow by the array factor of the four C-band columns 210a-d disposed along the x-axis direction in the azimuth plane. This is consistent with an 8T8R configuration.

Two features of exemplary array face configuration 200 provide for improved beam performance in the case of beamforming. The first is that the inner two C-band columns 210b/210c have more C-band dipoles 115 (seven) compared the number of C-band radiators 115 in outer C-band columns 210a/d (four). This results in the two inner C-band columns 210b/c radiating a further distance than from the two outer C-band columns 210a/d. The second is that the inner two C-band columns 210b/c are closer together than they each are to their adjacent outer C-band column 210a/d. This may have the effect of improving the gain pattern in scanning a service beam in that the sidelobes are reduced. In a further advantage, array face 200 may provide the same service beam pattern as conventional antennas but with fewer C-band dipoles 115.

Exemplary array face configuration 200 has six Midband dipoles 120 arranged in two columns of three. The Midband dipoles 120 may be configured for 4×4 MIMO operation whereby two RF signals are radiated by the three Midband dipoles 120 in the column to the left edge of reflector 205 (one per polarization), and two other RF signals are radiated by the Midband dipoles 120 in the column to the right edge of reflector 205 (one per polarization), resulting in 4×4 operation.

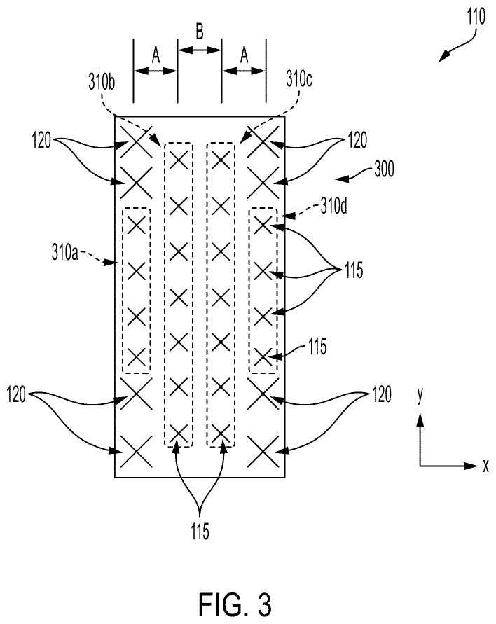

FIG. 3 illustrates an exemplary non-uniform array face configuration 300 according to the disclosure. Exemplary array face configuration 300 is another particular embodiment of array face 110. Exemplary array face configuration 300 may employ the same C-band dipoles 115 and Midband dipoles 120 as in exemplary array face configuration 200. In exemplary array face configuration 300, the C-band dipoles 115 are disposed on reflector 205 (not shown) in four C-band columns 310a, 310b, 310c, and 310d. Of the four C-band columns are two inner C-band columns 310b/c and two outer C-band columns 310a/d. Also disposed on reflector 205 is a plurality of Midband dipoles 120 that are arranged in four clusters of two dipoles. The clusters have Midband dipoles 120 arranged columns. Each of the clusters is disposed colinear with a corresponding outer C-band column 310a/d.

In this exemplary configuration, C-band columns 310a/d are spaced along the x-axis direction at the same distances A and B as in exemplary array face configuration 200. However, their respective location along the y-axis is different. For example, outer C-band columns 310a and 310b are shifted downward along the y-axis direction so that they are substantially centered with the inner C-band columns 310b and 310c. Having the C-band columns 310a-d arranged in this manner provides the same benefits in gain performance as in exemplary array face configuration 200. However, the arrangement of C-band columns 310a-d of exemplary array face configuration 300 provides sufficient space for four clusters of Midband dipoles 120 such that a total of eight Midband dipoles 120 are possible, as opposed to a total of six dipoles with array face configuration 200. This may enable 4×4 MIMO with increased gain due to the additional pair of Midband dipoles 120. Alternatively, it may enable 8×8 MIMO, with two Midband dipoles 120 per channel pair.

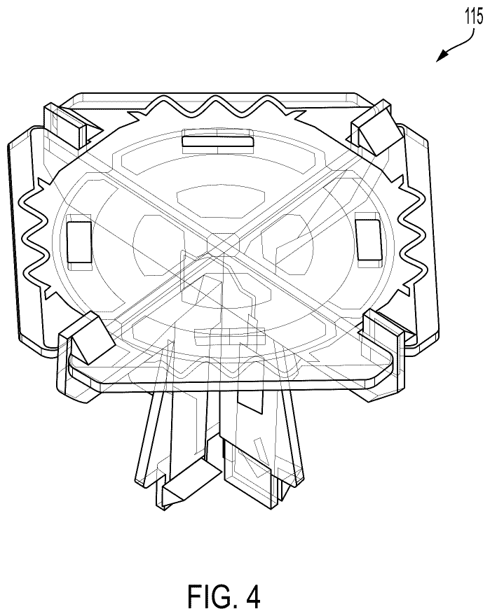

FIG. 4 illustrates an exemplary C-band dipole 115 according to the disclosure. An example of C-Band dipole 115 may be that described in published PCT patent application WO2023/172716, ULTRA WIDE BAND MINIATURIZED DIPOLE ANTENNA WITH IMPROVED GAIN AND BEAM STABILITY, which is owned by the applicant of the present application and incorporated by reference as if fully disclosed herein. The disclosed dipoles in the reference are exemplary and other C-band dipoles may be used.

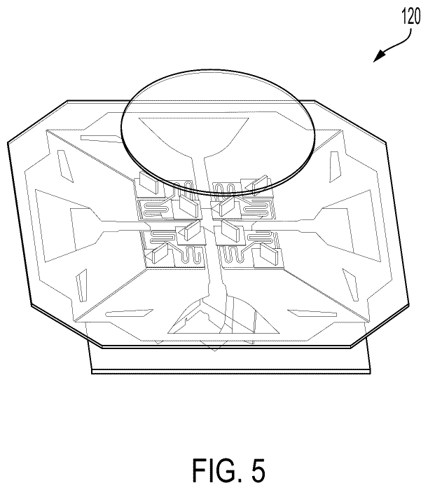

FIG. 5 illustrates an exemplary Midband dipole 120 according to the disclosure. An example of Midband dipole 120 may be that described in granted U.S. Pat. No. 11,605,893, BROADBAND DECOUPLED MIDBAND DIPOLE FOR A DENSE MULTIBAND ANTENNA, which is owned by the applicant of the present application and incorporated by reference as if fully disclosure herein. The disclosed dipoles in the reference are exemplary and other C-band dipoles may be used, provided that they have low profile, low cross polarization, and good impedance matching.

Although array face configurations 200/300 are described as being used in an arrangement of three array faces 110a/b/c in a quasi-omni deployment, it will be understood that the disclosed array face configurations 200/300 may be used in other antenna configurations, such as a macro antenna. It will be understood that such variations are possible and within the scope of the disclosure. In another possible variation, more columns of Midband dipoles 120 and/or more C-band columns 210/310 may be deployed outer to C-band columns 210a/d or 31-a/d.

Although the above discussion describes first dipoles of a first frequency band being C-band dipoles, and second dipoles of a second frequency band being the Midband, it will be understood that other frequency bands may be used provided that the first frequency band is at a higher frequency than the second frequency band, and that the first dipoles and second dipoles have cloaking features that make each invisible to RF energy of the other frequency band. It will be understood that such variations are possible and within the scope of the disclosure.

1. An antenna array, comprising:
a reflector;
a plurality of first dipoles disposed on the reflector, the plurality of first dipoles arranged in a plurality of columns; and
a plurality of second dipoles disposed on the reflector, the plurality of second dipoles arranged in a plurality of clusters,
wherein each of the the plurality of first dipoles is configured to radiate in a first frequency band, and each of the plurality of second dipoles is configured to radiate in a second frequency band, wherein the first frequency band is higher in frequency than the second frequency band,
wherein the plurality of columns comprises two inner columns and two outer columns, wherein the two inner columns have more first dipoles than the two outer columns,
wherein the two inner columns are spaced apart along a horizontal axis by a first distance and wherein the two outer columns are respectively spaced apart along the horizontal axis from an adjacent one of the two inner columns by a second distance, the second distance being greater than the first distance.

2. The antenna array of claim 1, wherein each of the inner columns comprises seven first dipoles and each of the outer columns comprises four dipoles.

3. The antenna array of claim 1, wherein the plurality of clusters comprises two clusters.

4. The antenna array of claim 3, wherein each of the two clusters comprises three second dipoles arranged in one of two second dipole columns, respectively; and wherein each of the two second dipole columns is colinear with a corresponding one of the two outer columns.

5. The antenna array of claim 1, wherein the plurality of clusters comprises four clusters.

6. The antenna array of claim 5, wherein each of the four clusters comprises two second dipoles arranged in respective second dipole columns; and wherein each of the second dipole columns is colinear with one of the two outer columns.

7. The antenna array of claim 1, wherein the plurality of first dipoles is configured to operate as an 8T8R (Eight Transmit Eight Receive) array.

8. The antenna array of claim 1, wherein the plurality of second dipoles is configured to operate as a 4×4 MIMO (Multiple Input Multiple Output) array.

9. The antenna array of claim 1, wherein the first frequency band comprises a C-band.

10. The antenna array of claim 12, wherein the second frequency band comprises a Midband.

11. A quasi-omni antenna comprising:
a plurality of array faces, wherein each array face of the plurality of array faces is offset in azimuth from each of two adjacent array faces by a same fixed angle, each of the plurality of array faces comprising:
a reflector;
a plurality of first dipoles disposed on the reflector, the plurality of first dipoles arranged in a plurality of columns; and
a plurality of second dipoles disposed on the reflector, the plurality of second dipoles arranged in a plurality of clusters,
wherein each of the the plurality of first dipoles is configured to radiate in a first frequency band, and each of the plurality of second dipoles is configured to radiate in a second frequency band, wherein the first frequency band is higher in frequency than the second frequency band,
wherein the plurality of columns comprises two inner columns and two outer columns, wherein the two inner columns have more first dipoles than the two outer columns,
wherein the two inner columns are spaced apart along a horizontal axis by a first distance and wherein the two outer columns are respectively spaced apart along the horizontal axis from an adjacent one of the two inner columns by a second distance, the second distance being greater than the first distance.

12. The quasi-omni antenna of claim 11, wherein the plurality of array faces is three and the fixed angle is 120 degrees.

13. The quasi-omni antenna of claim 12, wherein each of the inner columns of each of the three array faces comprises seven first dipoles and each of the outer columns comprises four dipoles.

14. The quasi-omni antenna of claim 12, wherein the plurality of clusters of each of the three array faces comprises two clusters.

15. The quasi-omni antenna of claim 14, wherein each of the two clusters comprises three second dipoles arranged in one of two second dipole columns, respectively; and wherein each of the two second dipole columns is colinear with a corresponding one of the two outer columns.

16. The quasi-omni antenna of claim 12, wherein the plurality of clusters of each of the three array faces comprises four clusters.

17. The quasi-omni antenna of claim 16, wherein each of the four clusters comprises two second dipoles arranged in respective second dipole columns; and wherein each of the second dipole columns is colinear with one of the two outer columns.

18. The quasi-omni antenna of claim 12, wherein the plurality of first dipoles of each of the plurality of array faces is configured to operate as an 8T8R (Eight Transmit Eight Receive) array.

19. The quasi-omni antenna of claim 12, wherein the plurality of second dipoles of each of the plurality of array faces is configured to operate as a 4×4 MIMO (Multiple Input Multiple Output) array.

20. The quasi-omni antenna of claim 12, wherein the first frequency band comprises a C-band; and wherein the second frequency band comprises a Midband.
